(19) United States
(12) Patent Application Publication
(10) Pub. No.: US 2006/0168610 A1
(43) Pub. Date: Jul. 27, 2006

(54) System and method of managing content

(75) Inventors: Alyssa Lenorah Noil Williams, Elmhurst, IL (US); James L. Cansler JR., Pflugerville, TX (US); Philip Ted Kortum, Austin, TX (US); Marc Andrew Sullivan, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/043,443

(22) Filed: Jan. 26, 2005

(51) Int. Cl. H04N 7/16

(52) U.S. Cl. 725/9

(57) ABSTRACT

Systems and methods can be implemented to allow restricted content to be available using an apparatus within a system, while still protecting the privacy or one or more users. Metadata regarding restricted content may not be displayed if the user so desires or if other users do not have proper access. In this manner, visitors of the user or the user's own children may not be aware that restricted content is available. Metadata regarding the restricted data is not displayed.

### BACKGROUND

1. Field of the Disclosure

The present disclosure relates to systems and methods of managing content, and more particularly to content controls that restrict who can view data related to content or any portion thereof.

2. Description of the Related Art

Parental controls for limiting access to adult content are conventional. The controls are typically defined in a set of rules. The rules may be based on a rating or based on a keyword. While the parental controls can be used to limiting access to adult content, they do not completely address privacy concerns. If adult content has been downloaded, a directory of the content stored locally may include the titles of the adult content (e.g., “Debbie Does Dallas,” etc.) or the titles may be masked by replacing the title with “Adult Content” or the like. The mere fact that adult content has been downloading may be embarrassing to the user when other family members or friends see the directory listing, even if they cannot access the content.

### BRIEF DESCRIPTION OF THE DRAWINGS

FIG. 1 includes a block diagram of a home entertainment system.

FIG. 2 includes a block diagram of an apparatus that can be used with the home entertainment system of FIG. 1.

FIG. 3 includes a block diagram of a control module within the apparatus of FIG. 2.

FIG. 4 includes a flow diagram of a method of managing metadata using the system of FIG. 1.

FIGS. 5-8 include illustrations of screen shots that can be displayed using the method of FIG. 4.

FIG. 9 includes a flow diagram of a method of managing content using the system of FIG. 1.

FIGS. 10 and 11 include illustrations of screen shots that can be displayed using a method in accordance with an alternative embodiment.

FIG. 12 includes a flow diagram of an alternate embodiment of a method of managing metadata and content using the system of FIG. 1.

Skilled artisans appreciate that elements in the figures are illustrated for simplicity and clarity and have not necessarily been drawn to scale.

### DETAILED DESCRIPTION

Systems and methods can be implemented to allow restricted content to be available using an apparatus within a system, while still protecting the privacy of one or more users. Metadata regarding restricted content may not be displayed if the user so desires or if other users do not have proper access. In this manner, visitors of the user or the user's own children may not be aware that restricted content is available. Metadata regarding the restricted data is not displayed.

In one aspect, a method is disclosed for managing available content using an apparatus. The method includes accessing metadata regarding content available at the apparatus. First metadata includes a first identifier for a first portion of the content that is designated only for a restricted audience, and second metadata includes a second identifier for a second portion of the content that is not designated solely for the restricted audience. The method also includes determining a metadata viewing state relating to access to the first metadata. When the metadata viewing state is in a first state, a first display signal includes the first and second metadata, but does not include all of the content associated with the first or second metadata. When the metadata viewing state is in a second state, the first display signal includes the second metadata but does not include the first metadata or all of the content associated with any of the first and second metadata.

In one embodiment, the method further includes filtering the first and second metadata in response to determining the metadata viewing state before sending the first display signal. In another embodiment, the method further includes determining a content viewing state related to access to the content. When the content viewing state is in a first state, a second display signal includes at least part of the first portion of the content. In a particular embodiment, when the content viewing state is in a second state, the first portion of the content is not displayed by the display subsystem. In a particular embodiment, when the content viewing state is in a second state, no second display signal is generated. In another particular embodiment, when the content viewing state is in a second state, the method further includes blocking the second display signal before the second display signal is displayed using the display subsystem.

In another embodiment, the method is performed without masking at least a part of the first metadata.

In another aspect, a method is disclosed for managing content available using an apparatus. The method includes accessing metadata regarding content available at the apparatus. The apparatus contains no portion of the content that is designated only for a restricted audience, and the metadata includes an identifier for the content that is not designated solely for the restricted audience. The method also includes determining a metadata viewing state relating to access to the first metadata, wherein when the metadata viewing state is in a first state, a first display signal includes an indicator that no portion of the content within the apparatus is designated only for a restricted audience.

In another embodiment, when the metadata viewing state is in a second state, the first display signal includes the metadata but does not include the indicator. In a particular embodiment, when the metadata viewing state is in the first state, the first display signal also includes the metadata, but does not include all of the content associated with the metadata.

In still another aspect, the method includes determining a viewing state regarding access to the content and metadata of the content within the apparatus. The content includes a first portion that is designated only for a restricted audience, and the metadata includes first metadata that includes a first identifier corresponding to the first portion of the content. When the viewing state is in a first state, the method also includes sending a display signal to a display subsystem. The first state corresponds to a selection allowing the first portion of the content, the first metadata, or a combination thereof to be displayed. The display signal includes the first portion of the content, the first metadata, or a combination thereof.

In another embodiment, when the viewing state is in a second state, none of the first metadata and the first portion of the content are displayed using the display subsystem. In a particular embodiment, when the viewing state is in the second state, no display signal is generated corresponding to the first metadata or the first portion of the content. In another particular embodiment, when the viewing state is in the second state, the method further includes blocking the second display signal before the second display signal is displayed using the display subsystem.

In a further aspect, a system includes a metadata access engine that is configured to access metadata regarding content available at the system. First metadata includes a first identifier for a first portion of the content that is designated only for a restricted audience, and second metadata includes a second identifier for a second portion of the content that is not designated solely for the restricted audience. The system also includes a metadata viewing state engine that is configured to determine a metadata viewing state relating to access to the first metadata. When the metadata viewing state is in a first state, a first display signal includes the first and second metadata, but does not include all of the content associated with the first or second metadata. When the metadata viewing state is in a second state, the first display signal includes the second metadata but does not include the first metadata or all of the content associated with any of the first and second metadata. The system also includes a display subsystem configured to receive the first display signal.

In one embodiment, the metadata viewing state engine is further configured to filter the first and second metadata in response to determining the metadata viewing state before sending the first display signal. In another embodiment, the system further includes a content viewing state engine configured to determine a content viewing state related to access to the content, and when the content viewing state is in a first state, a second display signal includes at least part of the first portion of the content. In a particular embodiment, when the content viewing state is in a second state, the first portion of the content is not displayed by the display subsystem. In a particular embodiment, when the content viewing state is in a second state, the content viewing state engine is configured not to generate a second display signal. In a further particular embodiment, when the content viewing state is in a second state, the display subsystem is configured to block the second display signal.

In a further embodiment, the display subsystem is not configured to mask at least a part of the first metadata. In still a further embodiment, the content includes one or more movies, one or more broadcast programs, one or more pictures, or a combination thereof.

In still a further aspect, a system for managing content includes a metadata access engine that is configured to access metadata associated with the content. The apparatus contains no portion of the content that is designated only for a restricted audience, and metadata includes an identifier for the content that is not designated solely for the restricted audience. The system also includes a metadata viewing state engine that is configured to determine a metadata viewing state relating to access to the first metadata, wherein when the metadata viewing state is in a first state, a first display signal includes an indicator that no portion of the content within the apparatus is designated only for a restricted audience. The system further includes a display subsystem configured to receive the first display signal.

In one embodiment, when the metadata viewing state is in a second state, the first display signal includes the second metadata but does not include the first metadata or all of the content associated with any of the first and second metadata. In a particular embodiment, when the metadata viewing state is in the first state, the first display signal also includes the second metadata, but does not include all of the content associated with the first or second metadata.

In yet a further apsect, a system for managing content is disclosed. The content includes a first portion that is designated only for a restricted audience, and metadata includes first metadata that includes a first identifier corresponding to the first portion of the content. The system also includes a viewing state engine configured to determine a viewing state regarding access to the content and metadata of the content within the apparatus and when the viewing state is in a first state, to send a display signal to a display subsystem. The first state corresponds to a selection allowing the first portion of the content, the first metadata, or a combination thereof to be displayed, and the display signal includes the first portion of the content, the first metadata, or a combination thereof. The system further includes a display subsystem configured to receive the display signal.

In one embodiment, when the viewing state is in a second state, none of the first metadata and none of the first portion of the content can be displayed by the display subsystem. In a particular embodiment, when the viewing state is in the second state, the viewing state engine is configured not to generate the display signal. In another particular embodiment, when the viewing state is in the second state, the display subsystem is further configured to block the display signal. In another embodiment, the content includes one or more movies, one or more broadcast programs, one or more pictures, or a combination thereof.

Before addressing details of embodiments described below, some terms are defined or clarified. The term “restricted” refers to content, metadata regarding the content, or a combination thereof that is not meant for viewing by at least a portion of potential users of a system. The basis for determining the restriction can be based on maturity level (e.g., adult content), who has or has not paid a fee, gender, age, nearly any other classification, or any combination thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Unless stated otherwise, any combination of parts of a system may be bi-directionally or uni-directionally coupled to each other, even though a figure may illustrate only a single-headed arrow or a double-headed arrow. Arrows within the drawing are illustrated, as a matter of convenience, to show a principal information, data, or signal flow within the system or between the system and one or more component outside the system, one or more modules outside the system, another system, or any combination thereof in accordance with an embodiment. Coupling should be construed to include a direct electrical connection in one embodiment and alternatively, may include any one or more of an intervening switch, resistor, capacitor, inductor, router, firewall, network fabric or the like between any combination of one or more component, one or more devices, or one or more modules.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific network, hardware, software, and firmware components and acts are conventional and may be found in textbooks and other sources within any one or more of the multimedia, information technology, networking and telecommunications arts.

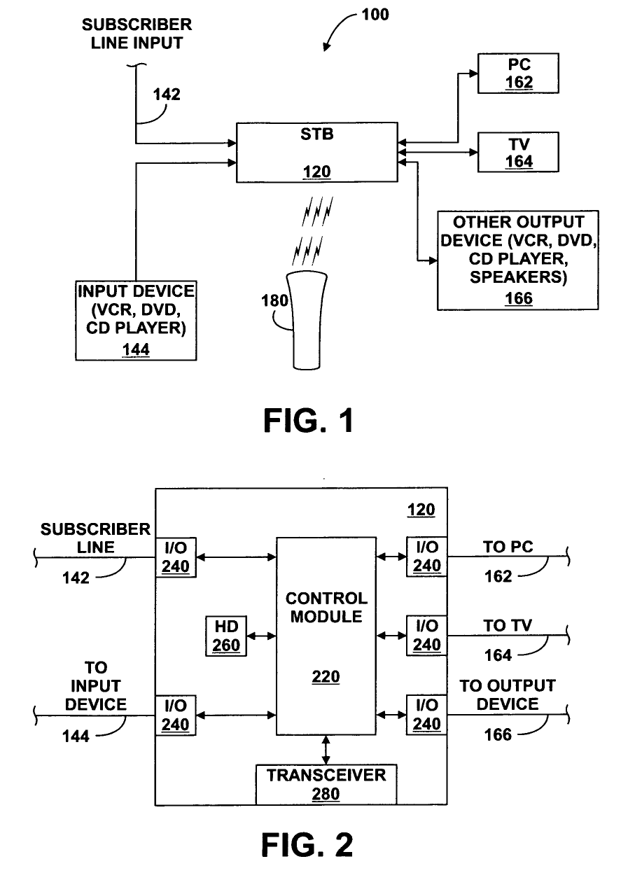

FIG. 1 includes a block diagram of a system 100. The system 100 can be centrally controlled by an apparatus 120. The apparatus 120 may receive input from any one or more sources including a subscriber line 142, which may be connected to the an internet service provider, a cable service provider, a satellite dish, a telephone line, another conventional type of subscriber line (wired or wireless), or any combination thereof. The apparatus 120 may also be connected to an input device 144. An example of the input device 144 can include a video cassette recorder (“VCR”), a digital video disk (“DVD”) player, an audio compact disc (“CD”) player, another conventional device that may be used in conjunction with a home entertainment system, or any combination thereof. The apparatus 120 may provide output to a personal computer (“PC”) 162, a television (“TV”) 164, or other output device 166. An example of the output device 166 can include a VCR, a DVD player, a CD burner, speakers, another conventional output device used with a home entertainment system, or any combination thereof. In one embodiment, each of the subscriber line 142, input device 144, personal computer 162, television 164, and output device 166 are bi-directionally coupled to the apparatus 120. In another embodiment, the subscriber line 142, input device 144, personal computer 162, television 164, output device 166, or any combination thereof may be directly connected to the apparatus 120, or may be uni-directionally coupled or connected to the apparatus 120 (allows signals to flow in only one direction).

The apparatus 120 can be controlled by a remote control 180. The remote control 180 can communicate with the apparatus 120 using electronic signals, radio-frequency signals, optical signals, signals using other electromagnetic radiation, or any combination thereof. In one embodiment, the remote control 180 does not need to contact or otherwise be tethered to the apparatus 120. In another embodiment (not illustrated), the remote control 180 can be coupled to the apparatus 120 using one or more wires.

FIG. 2 includes a block diagram to further illustrate some of the components and modules that provide functionality within the apparatus 120. In one embodiment, the apparatus 120 is a set-top box that can be connected to one or more input devices, one or more output devices, or any combination thereof. The apparatus 120 includes a control module 220 that controls a wide array of functions within the apparatus 120. The control module 220 is bi-directionally coupled to I/O modules 240. The I/O modules 240 are coupled to the subscriber line 142, the input device 144, the PC 162, the TV 164, and the output device 166 as illustrated in FIG. 2. In another embodiment, more or fewer input devices, more or fewer output devices, or a combination thereof, may be used with the apparatus 120. The control module 220 is also bi-directionally coupled to a transceiver 280. Transceiver 280 is capable of receiving signals from and sending signals to the remote control 180. In still another embodiment, the transceiver 280 can be replaced by a receiver (not illustrated) that receives signals from the remote control 180 and is coupled to the control module 220. A hard disk (“HD”) 260 is coupled to the control module 220. Stored content, such as movies, broadcast programs, pictures, audio files, or any combination thereof may be stored in HD 260. HD 260 can also include one or more software programs, data (e.g., tables), or a combination thereof for operating part or all of the system 100, and the apparatus 120 in particular.

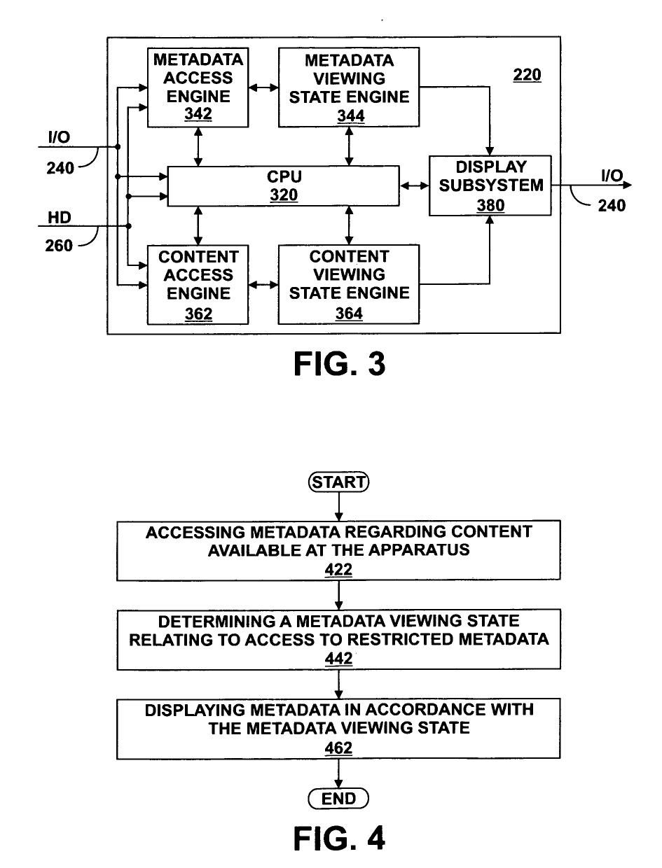

FIG. 3 includes a block diagram of the control module 220 in accordance with an embodiment. The control module can include a microcontroller, a microprocessor, a chipset, a motherboard, or a collection of different modules that provide the functionality described in this specification. The control module 220 includes a central processing unit (“CPU”) 320. The control module 220 also include a metadata access engine 342 that can be used to extract metadata from content available at the apparatus or obtain metadata without having to extract it from the content. The metadata access engine 342 is bi-directionally coupled to the any one or more of the input devices, HD 260, or a combination thereof. The control module further includes a metadata viewing state engine 344 that can be used to determine whether metadata can be displayed based on a metadata viewing state. The metadata viewing state engine 344 is bi-directionally coupled to the CPU 320 and the metadata access engine 342.

The control module may also include a content access engine 362 that can be used to obtain content, and content viewing state engine 364, which is similar to the metadata viewing state engine 344 except that the content viewing state engine 364 works with content (and potentially metadata) rather than just metadata. The content access engine 362 is bi-directionally coupled to the any one or more of the input devices, HD 260, or a combination thereof, and the content viewing state engine 364 is bi-directionally coupled to the CPU 320 and the content access engine 362.

The control module 220 can also include a display subsystem 380 that can send signals to any one or more output devices, based on the signals provided from the metadata viewing state engine 344, the content viewing state engine 364, or a combination thereof. The display subsystem 380 is bi-directionally coupled to the CPU 320, metadata viewing state engine 344, and the content viewing state engine 364.

Many other embodiments are possible for the control module 220. The control module 220 may include more, fewer, or different engines, one or more memories, or one or more other components. The engines illustrated within the control module 220 may be coupled or connected differently. For example, the metadata viewing state engine 344, the content viewing state engine 364, or both may be coupled to the HD 260 without requiring data to pass through the controller 320, the metadata access engine 342 or the content access engine 362 before reaching the metadata viewing state engine 344 or the content viewing state engine 364.

The apparatus 120, including the control module 220, is an example of a data processing system. Although not shown, other connections and memories may reside in or be coupled to any of the control module 220, another one or more portions of the apparatus, or any combination thereof. Although not shown, the apparatus 120 or control module 220 can include additional one or more memories including content addressable memory, static random access memory, cache, first-in-first-out (“FIFO”), other memories, or any combination thereof. The memories, including HD 260, can include media that can be read by the CPU 320. Therefore, each of those types of memories includes a data processing system readable medium.

Portions of the methods described herein may be implemented in suitable software code for carrying out the methods described. In one embodiment, the computer-executable instructions may be lines of assembly code or compiled C++, Java, or other language code. In another embodiment, the code may be contained on a data storage device, such as a hard disk, magnetic tape, floppy diskette, optical storage device, networked storage device(s), or other appropriate data processing system readable medium or storage device.

Functions preformed by any one or more of the engines may be combined with one or more other engines or the CPU 320. For example, the metadata access engine 342 and the content access engine 362 may be combined into a single engine, the metadata viewing state engine 344 and the content viewing state engine 364 may be combined into another single engine, the metadata access engine 342 and the metadata view state engine 344 may be combined into yet another single engine, or the content access engine 362 and the content viewing state engine 344 may be combined into a further single engine. Additionally, any one or more of the engines may be embodied in another portion of the apparatus 120 separate from the control module 220. In still another embodiment, one or more of the engines may be located outside of the apparatus 120. For example, the display subsystem 380 may be located within any one or more of the output devices. Also, any single engine may be embedded within a plurality of integrated circuits, chip sets, circuit boards, or the like. Additionally, a software program or its software components with such code may be embodied in more than one data processing system readable medium in more than one computer or other item having a CPU.

Attention is now directed to methods of using the system 100 in accordance with some illustrative, but not limiting, embodiments. The methods are described in more detail below.

The method illustrated in FIG. 4 allows access for viewing content and metadata regarding the content to be operated independently of one another. An administrator (e.g., a parent) of a home entertainment system 100 can set restriction levels to the metadata, content, or both based on the identity of the user. A register of users, one more passwords or one or more other codes for the users, and restriction levels for metadata, content, or both may be stored as a table in HD 260. A “guest” user may be reserved for users that are not registered. A guest may include a visitor to the household having the home entertainment system 100. The guest user typically has the highest level of restrictions (i.e., can access the least amount of metadata and content). The restrictions may be based on classification, as previously described. For household use, the restrictions may be based on the age or maturity level of the user. The same or different level of restrictions may be used for metadata and content viewing access.

When a user is operating the system 100, he or she may be prompted for the password(s) or other code(s). The password(s) or code(s) can be transmitted from the remote control 180 and received by the transceiver 280 of the apparatus. The information is forwarded to the control module 220. The control module 220 retrieves information from the table in the HD 260 in response to the information received from the user. If a match is found, the user identification is confirmed, and restrictions regarding metadata and content are obtained from the table. If no match is found, the user may be prompted for the password(s) or other code(s). The process may be iterated for nearly any number of times or may be terminated and not allow any access. Alternatively, the unidentified user or a user without a password or other code may be granted access as a guest user.

In another embodiment, password(s) or other code(s) may be requested at a different time. After reading this specification, skilled artisans will appreciate that the password(s) or code(s) may be requested only when restricted metadata or content is requested. The embodiments described with respect to time or location (in a process flow) for requesting password(s) or other code(s) are merely illustrative and are not limiting to the invention.

The user of the home entertainment system 100 may operate the remote control 180 to request metadata or content that is available using the apparatus 120. The signals can be received by the transceiver 280, which in turn are transmitted to the control module 220. In one embodiment, the user can request metadata corresponding to the content. The metadata can include any one or more of an identifier (e.g., a title or code), rating, cost, last date available to view, length, people involved with the content (e.g., actors, directors, producers, etc.), topic, genre, etc. The method can include accessing metadata regarding content available at the apparatus 120 (block 422 in FIG. 4). The metadata may be obtained using the metadata access engine 342. In one embodiment, the metadata may be obtained using a program guide, a video-on-demand guide, or other source over the subscriber line 142. In another embodiment, the metadata may be obtained from a table within the HD 260.

The method also includes determining a metadata viewing state related to access to the restricted metadata (block 442). If the apparatus 120 has not yet prompted the user for a password or other code, it may do so at this time. The metadata viewing state engine 344 can access the HD 260 and determine the restriction level of the user. The user may have no metadata restriction, meaning the user will be allowed to view any metadata. Alternatively, one or more different metadata restriction levels can be used. As the metadata restrictions become higher, the amount of metadata that the user will be allowed to view decreases. In one embodiment, the metadata state viewing engine 344 can act as a filter, which may allow all, part, or none of the metadata to be viewed.

The method further includes displaying metadata in accordance with the metadata viewing state (block 462). After the metadata has had been filtered, the filtered metadata is forwarded to the display subsystem 380, which in turn converts the filtered metadata into display signals. The display subsystem 380 can forward the display signals to an output device, which in turn displays the filtered metadata to the user.

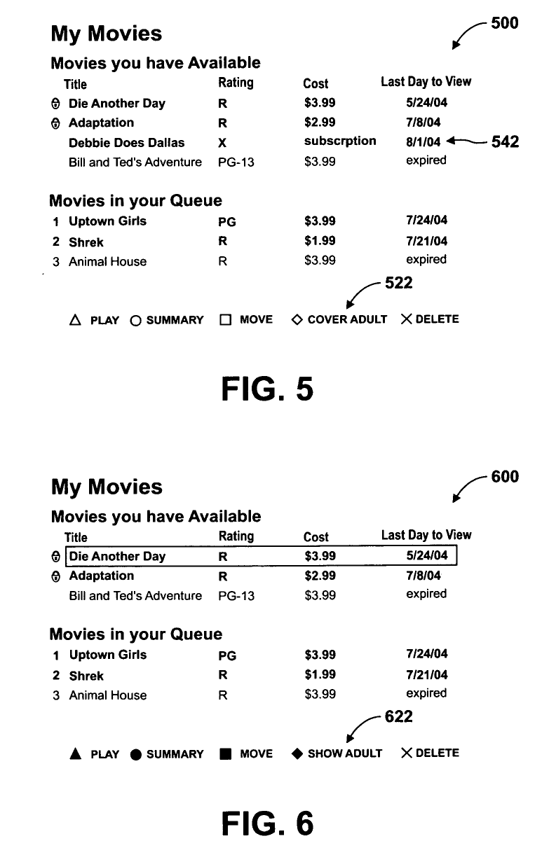

FIGS. 5-8 illustrate some exemplary screen shots that a user may see when using the method described with respect to FIG. 4. FIG. 5 includes an illustration of a screen shot 500 that can be presented to a user that is allowed to view restricted metadata (e.g., x-rated titles). In one embodiment, when restricted metadata is being viewed, a “cover adult” entry 522 is displayed. By activating the corresponding control on the remote control 180, the user can toggle back and forth between displaying restricted metadata and not displaying restricted metadata. One of the entries includes “Debbie Does Dallas,” which is a restricted entry 542.

When the user toggles the corresponding control, the screen shot 600 can be displayed, as illustrated in FIG. 6. The cover adult entry 522 is replaced by a “show adult” entry 622. Note that the restricted entry 542 does not show up in the screen shot 600 in FIG. 6. Also, in one embodiment, the restricted entry 542 is not masked. Masking would replace the restricted entry with “adult title” or other similar message. When a visitor is present and can see the display of the home entertainment system 100, displaying “adult title” may be embarrassing to the user, just as for the restricted title 542.

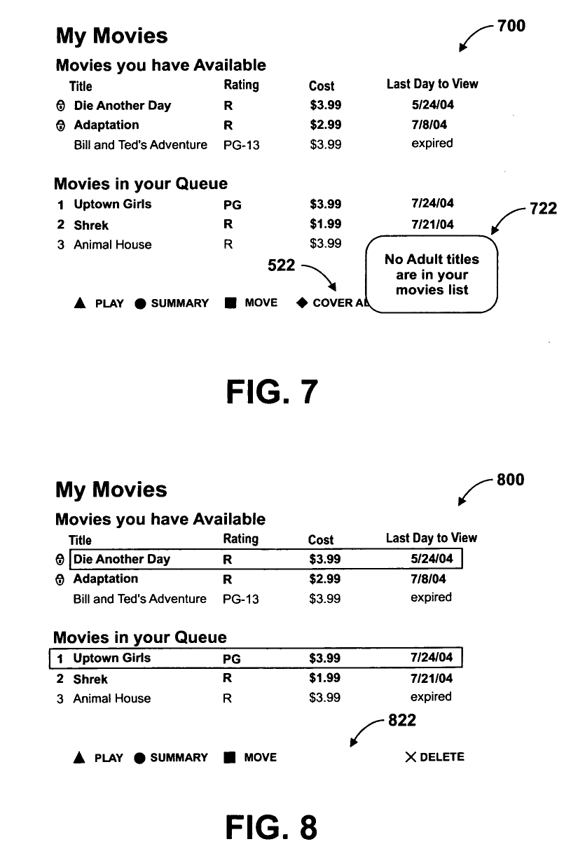

In one embodiment, no restricted metadata may be available at the apparatus 120. For example, the restricted entry 542 may be deleted. The next time the user requests the restricted metadata, an indicator 722 can be displayed, as illustrated in screen shot 700 of FIG. 7. In one embodiment, the indicator 722 displays “No Adult titles are in your movie list.” The indicator may provide many other different types of messages. The indicator 722 may be displayed for a predetermined amount of time or may be removed using a determined action, such as clicking on the indicator 722 or activating any control at the remote control 180.

In still another embodiment, the metadata restriction may be removed as illustrated in the screen shot 800 in FIG. 8. For example, the home entertainment system 100 may be principally used by only one user. In this embodiment, the user does not need to be prompted for password(s) or other code(s) to see any of the otherwise restricted metadata. The blank area 822 in FIG. 8 illustrates that the metadata restrictions, if any, are not active. Any metadata obtained using the metadata access engine 342 is displayed. In effect, the metadata viewing state engine 344 is deactivated.

If a user does not have access to the restricted metadata, the user may be provided with the screen shot 600 in FIG. 6 or the screen shot 800 in FIG. 8. If the screen shot 600 is displayed and the user were to activate the corresponding control for the show adult entry 622, the user may be prompted for a password or other code before the restricted metadata is displayed. In another embodiment, the user may be not be given the chance to even attempt to have the restricted metadata displayed. In this embodiment, the blank area 822 may be used. Unlike an embodiment first described with respect to FIG. 8 (e.g., metadata viewing state engine 344 deactivated), restricted metadata will not be displayed in this embodiment.

After viewing the metadata (restricted or not) as displayed, a user may select any of the content for viewing. In one embodiment, the user may double-click on any of the entries. In other embodiments, other ways of selecting the content may be used. The content may be obtained using the content access engine 362. The user may be allowed access to the content or may need to provide payment information before the content is accessible via the control module 220. The content may be obtained over the subscriber line 142 or from the HD 260.

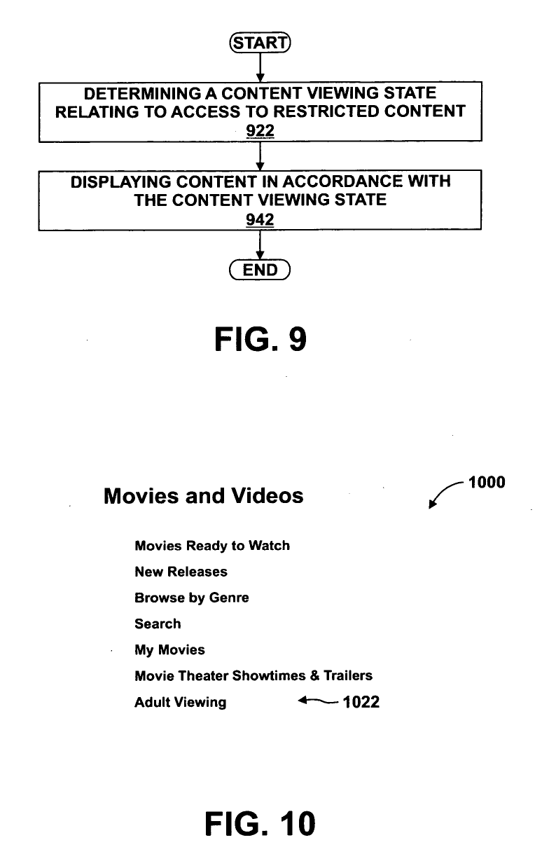

A method is disclosed that includes determining a content viewing state related to access to restricted content (block 922 in FIG. 9). If the apparatus 120 has not yet prompted the user for a password or other code, it may do so at this time. The content viewing state engine 364 can access the HD 260 and determine the restriction level of the user. Note that the metadata restrictions and content restrictions may be independent of each other. Therefore, the content restriction for the user may be the same or different from the metadata restriction for the same user. The user may have no content restrictions, meaning the user will be allowed to view any content. Alternatively, one or more different content restriction levels can be used. As the content restrictions become higher, the amount of content that the user will be allowed to view decreases. In one embodiment, the content state viewing engine 364 can act as a filter, which may allow all, part, or none of the content to be viewed.

The method further includes displaying content in accordance with the content viewing state (block 942). After the content has had been filtered, the filtered content is forwarded to the display subsystem 380, which in turn converts the filtered content into display signals. The display subsystem 380 can forward the display signals to an output device, which in turn displays the filtered content to the user.

Similar to the embodiment described initially with respect to FIG. 8, the home entertainment system 100 may have a single principal user. In one embodiment, the user may be able to deactivate the content viewing state engine 364. Any content that can be received by the control module 220 may be displayed to the user.

In another embodiment, the restricted metadata and restricted content may be reserved for a separate area and is only viewed separate from other (not restricted) metadata and content. Referring to FIG. 3, in this embodiment, the metadata viewing state engine 344 and content viewing state engine 364 may be replaced by a combined viewing state engine (not illustrated). The CPU 320, the metadata access engine 342, the content access engine 362, and the display subsystem 380 can be bi-directionally coupled to the combined viewing state engine.

The user of the home entertainment system 100 can display screen shot 1000 as illustrated in FIG. 10. One of the entries displayed is a restricted entry 1022, which is this embodiment is entitled “Adult Viewing.” Other than restricted metadata and content, all of the other entries in screen shot 1000 can access metadata or content available at the apparatus 120 or provide functions using such metadata, content, or both that is not restricted. The user may be prompted for password(s) or other code(s) at times and locations as previously described with respect to other embodiments. The home entertainment system 100 may default to a guest user status if the user does not have the proper password(s) or code(s).

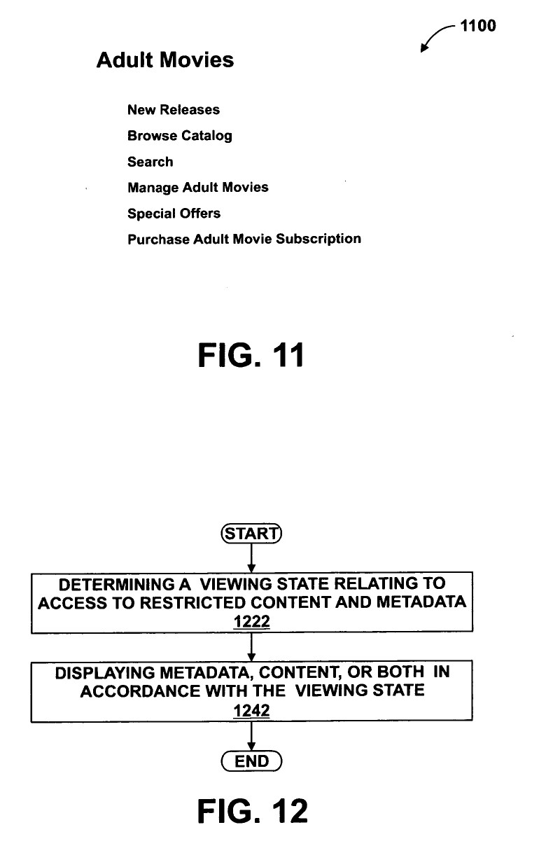

When the user selects the restricted entry 1022, the user may be prompted for a password or other code. Alternatively, the home entertainment system 100 may have already determined the identity and restrictions, if any, on the user. When the user has proper authority to see the restricted metadata and restricted content, the home entertainment system 100 can display screen shot 1100 as illustrated in FIG. 11. The organization of information within the screen shot 1100 may be similar to the organization of information within a screen shot for a user that is restricted from reaching screen shot 1100. For example, “Adult Movies” may be entitled “Movies” and all other entries with “Adult” would have the word “Adult” deleted. In this manner functionality between restricted and unrestricted metadata and content is substantially the same.

In another embodiment, the restricted entry 1022 may not be displayed if the user does not have the proper authority for the restriction level.

When the user accesses restricted metadata, restricted content, or both using the restricted display (e.g., screen shot 1100), the metadata access engine 342, the content access engine 362, or both can access metadata and content available over the subscriber line 142 or within the apparatus (e.g., on the HD 260). The method can include determining a viewing state relating to access to restricted content and metadata (block 1222 in FIG. 12). The combined viewing state engine would operate similarly as previously described with respect to the metadata viewing state engine 344 and the content viewing state engine 364. The method can also include displaying metadata, content, or both in accordance with the viewing state, at block 1242. In other words, it can display the restricted metadata, restricted content, or both.

The systems, including portions thereof, and methods help to maintain the privacy of the user of the home entertainment system 100. The ability to prevent restricted metadata or masked metadata (e.g., “Adult Title,” etc.) from being displayed helps to reduce the likelihood that visitors to the user's household or other users of the home entertaining system 100 would be aware that any restricted content is available using the apparatus 120. While conventional restrictions may prevent viewing of restricted content, they do not effectively protect the user's privacy by limiting access to metadata.

While a focus of the flow diagrams (FIGS. 4, 9, and 12) have been on methods, after reading this specification, skilled artisans will appreciate that appropriate logic can be generated for the home entertainment system 100 (and particularly, the apparatus 120) to perform part or all of the methods described herein. After reading the specification, skilled artisans will appreciate that they have many options regarding the design and use of the system 100.

After reading this specification, skilled artisans will appreciate that many other embodiments are possible. Therefore the embodiments described should be viewed as illustrative and not limiting to the scope of the present invention.

Note that not all of the activities described above in the general description or the examples are required, that a portion of a specific activity may not be required, and that one or more further activities may be performed in addition to those described. Still further, the order in which activities are listed are not necessarily the order in which they are performed. After reading this specification, skilled artisans will be capable of determining what activities can be used for their specific needs or desires.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above-disclosed subject matter is to be considered illustrative, and riot restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of managing content available using an apparatus, the method comprising:
accessing metadata regarding content available at the apparatus, wherein:
first metadata comprises a first identifier for a first portion of the content that is designated only for a restricted audience; and
second metadata comprises a second identifier for a second portion of the content that is not designated solely for the restricted audience;
determining a metadata viewing state relating to access to the first metadata, wherein:
when the metadata viewing state is in a first state, a first display signal includes the first and second metadata, but does not include all of the content associated with the first or second metadata; and
when the metadata viewing state is in a second state, the first display signal includes the second metadata but does not include the first metadata or all of the content associated with any of the first and second metadata.

2. The method of claim 1, further comprising filtering the first and second metadata in response to determining the metadata viewing state before sending the first display signal.

3. The method of claim 1, further comprising:
determining a content viewing state related to access to the content; and
when the content viewing state is in a first state, a second display signal includes at least part of the first portion of the content.

4. The method of claim 3, wherein when the content viewing state is in a second state, the first portion of the content is not displayed by the display subsystem.

5. The method of claim 4, wherein when the content viewing state is in a second state, no second display signal is generated.

6. The method of claim 4, wherein when the content viewing state is in a second state, the method further comprises blocking the second display signal before the second display signal is displayed using the display subsystem.

7. The method of claim 1, wherein the method does not include masking at least a part of the first metadata.

8. A method of managing content available using an apparatus, the method comprising:
accessing metadata regarding content available at the apparatus, wherein:
the apparatus contains no portion of the content that is designated only for a restricted audience; and
the metadata comprises an identifier for the content, that is not designated solely for the restricted audience;
determining a metadata viewing state relating to access to the first metadata,
wherein when the metadata viewing state is in a first state, a first display signal includes an indicator that no portion of the content within the apparatus is designated only for a restricted audience.

9. The method of claim 8, wherein when the metadata viewing state is in a second state, the first display signal includes the metadata but does not include the indicator.

10. The method of claim 9, wherein when the metadata viewing state is in the first state, the first display signal also includes the metadata, but does not include all of the content associated with the metadata.

11. A method of managing content at an apparatus, the method comprising:
determining a viewing state regarding access to the content and metadata of the content within the apparatus, wherein the content comprises a first portion that is designated only for a restricted audience, and the metadata comprises first metadata that includes a first identifier corresponding to the first portion of the content; and
when the viewing state is in a first state, sending a display signal to a display subsystem, wherein:
the first state corresponds to a selection allowing the first portion of the content, the first metadata, or a combination thereof to be displayed; and
the display signal includes the first portion of the content, the first metadata, or a combination thereof.

12. The method of claim 11, wherein when the viewing state is in a second state, none of the first metadata and the first portion of the content are displayed using the display subsystem.

13. The method of claim 12, wherein when the viewing state is in the second state, no display signal is generated corresponding to the first metadata or the first portion of the content.

14. The method of claim 12, wherein when the viewing state is in the second state, the method further comprising blocking the second display signal before the second display signal is displayed using the display subsystem.

15. A system for managing content, the system comprising:
a metadata access engine that is configured to access metadata regarding content available at the system, wherein:
first metadata comprises a first identifier for a first portion of the content that is designated only for a restricted audience; and
second metadata comprises a second identifier for a second portion of the content that is not designated solely for the restricted audience;
a metadata viewing state engine that is configured to determine a metadata viewing state relating to access to the first metadata, wherein:
when the metadata viewing state is in a first state, a first display signal includes the first and second metadata, but does not include all of the content associated with the first or second metadata; and
when the metadata viewing state is in a second state, the first display signal includes the second metadata but does not include the first metadata or all of the content associated with any of the first and second metadata; and
a display subsystem configured to receive the first display signal.

16. The system of claim 15, wherein the metadata viewing state engine is further configured to filter the first and second metadata in response to determining the metadata viewing state before sending the first display signal.

17. The system of claim 15, further comprising a content viewing state engine configured to:
determine a content viewing state related to access to the content; and
when the content viewing state is in a first state, a second display signal includes at least part of the first portion of the content.

18. The system of claim 17, wherein when the content viewing state is in a second state, the first portion of the content is not displayed by the display subsystem.

19. The system of claim 18, wherein when the content viewing state is in a second state, the content viewing state engine is configured not to generate a second display signal.

20. The method of claim 19, wherein when the content viewing state is in a second state, the display subsystem is configured to block the second display signal.

21. The system of claim 15, wherein the display subsystem is not configured to mask at least a part of the first metadata.

22. The system of claim 15, wherein the content includes one or more movies, one or more broadcast programs, one or more pictures, or a combination thereof.

23. A system for managing content available using an apparatus, the system comprising:
a metadata access engine that is configured to access metadata regarding the content, wherein:
the apparatus contains no portion of the content that is designated only for a restricted audience; and
metadata comprises an identifier for the content, that is not designated solely for the restricted audience;
a metadata viewing state engine that is configured to determine a metadata viewing state relating to access to the first metadata, wherein when the metadata viewing state is in a first state, a first display signal includes an indicator that no portion of the content within the apparatus is designated only for a restricted audience; and
a display subsystem configured to receive the first display signal.

24. The system of claim 23, wherein when the metadata viewing state is in a second state, the first display signal includes the second metadata but does not include the first metadata or all of the content associated with any of the first and second metadata.

25. The system of claim 24, wherein when the metadata viewing state is in the first state, the first display signal also includes the second metadata, but does not include all of the content associated with the first or second metadata.

26. A system comprising:
content stored within an apparatus, the content comprising a first portion that is designated only for a restricted audience, and metadata comprising first metadata that includes a first identifier corresponding to the first portion of the content;
a viewing state engine configured to:
determine a viewing state regarding access to the content and metadata of the content within the apparatus; and
when the viewing state is in a first state, send a display signal to a display subsystem, wherein:
the first state corresponds to a selection allowing the first portion of the content, the first metadata, or a combination thereof to be displayed;
the display signal includes the first portion of the content, the first metadata, or a combination thereof; and
a display subsystem configured to receive the display signal.

27. The system of claim 26, wherein when the viewing state is in a second state, none of the first metadata and none of the first portion of the content can be displayed by the display subsystem.

28. The system of claim 27, wherein when the viewing state is in the second state, the viewing state engine is configured not to generate the display signal.

29. The system of claim 27, wherein when the viewing state is in the second state, the display subsystem is further configured to block the display signal.

30. The system of claim 26, wherein the content includes one or more movies, one or more broadcast programs, one or more pictures, or a combination thereof.
